(19) United States
(12) Patent Application Publication
(10) Pub. No.: US 2004/0230453 A1
(43) Pub. Date: Nov. 18, 2004

(54) Method for measuring contract quality/risk

(76) Inventor: Charles Edward Belmore, Oviedo, FL (US)

Correspondence Address: Charles Belmore, 822 Palmetto Terrace, Oviedo, FL, 32765, US

(21) Appl. No.: 10/847,481

(22) Filed: May 17, 2004

Related U.S. Application Data
(60) Provisional application No. 60/470,977, filed on May 16, 2003.

(51) Int. Cl. G06F 17/60

(52) U.S. Cl. 705/1

(57) ABSTRACT

A method for measuring contract quality/risk comprising steps for reducing multiple contract clauses into multiple single clause elements. The clause elements are weighted for the creation of Comparative Contract Quality/Risk Reference Ranges for comparative analysis. The method provides numeric negotiation targets to identify reasonableness of proposed contract. The method also provides for adjusting a contracts prices to reflect contract risk/quality.

### CROSS REFERENCE TO RELATED APPLICATIONS

This application is based on U.S. provisional application serial No. 60/470/977, filed on May 16, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of contract management and more specifically to a process for measuring contract risk/quality. Contracts document the obligation, benefits, and limitations which describe the risks, responsibilities and rewards for each party both parties. Both parties often have competing interests, objectives and concerns and it is considered vital that they are documented properly. It is not uncommon for each party in a deal to have a pre-written contract containing a considerable number of clauses.

Negotiators deeply influence the quality of a deal's outcome. Contract negotiations by nature are decentralized, unstructured, and without measurable objectives. Once contract negotiation begins and the contract clauses are modified, the obligations, benefits, and limitations of all parties are subject to change. The extent that these changes affect the overall contract risk and quality is determined largely by the individual or individuals negotiating the deal. The contract quality determination is fundamentally based on their personal experiences, which varies significantly from one individual to another.

Over time contract management systems have been developed to track contract clauses, monitor changes, track approvals and to generate contract documents. Prior works have addressed such attributes as document storage and retrieval, template development, contract design, identification of modified clauses by whom, and the approval process. Prior technology has not however developed substantiating metrics, and objective data sets to measure contract quality or risk level. Prior technology has not developed methods to measure contract quality or risk. Individuals and organizations have high opinions of their respective negotiating abilities to achieve low risk high quality contracts yet how does one really know the level of risk/quality without any objective means to justify these opinions or prove it. Accurate substantiating data, to measure contract risk/quality is vital for justification of contract quality and for the improvement future negotiated contracts.

### BRIEF SUMMARY OF THE INVENTION

It is therefore a primary objective of the present invention to provide a method for measuring Contract Risk/Quality;

Another object of the invention is a process for creating Comparative Contract Risk/Quality Reference Ranges;

Another object of the invention is a process for creating Negotiation Targets;

A further object of the invention is a process for adjusting contract price to reflect Contract Risk/Quality; and

Yet another object of the invention is to provide a method for determining the best deal value between competing contracts;

Other objects and advantages of the present invention will become apparent from the following descriptions, taken in connection with the accompanying drawings, wherein, by way of illustration and example, an embodiment of the present invention is disclosed. In accordance with a preferred embodiment of the invention, there is disclosed a process for measuring Contract Risk/Quality comprising: a means creating a Master Contract Clause Database, a means to reduce the Master Contract Clause Database to individual elements, a means to weight individual clause elements, a means to extract the clause element data from individual contracts being evaluated, a means to input new data elements, a means to update the data base, a means for accessing the system from remote locations, a means to identify, track, and report a plurality of data points, and, a means for commercial business computer and software to store, manipulate, and report such data.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a sample of an assignment clause for a typical software license contract.

FIG. 2 is a display page of multiple assignment contract clauses reduced to declarative clause descriptions.

FIG. 3 is a display representing comparative contract clause data fields collect.

FIG. 4 is a display representing comparative contract business data fields collected.

FIG. 5 is a display presenting the Comparative Contract Risk/Quality Reference Ranges.

FIG. 6 is a display presenting the Comparative Contract Risk/Quality Reference Ranges of multiple verticals.

FIG. 7 is a display of the Negotiation Target Factor Table.

FIG. 8 is a display presenting the Comparative Contract Risk/Quality Negotiation Targets for multiple verticals.

FIG. 9 is a display of the Price and Quality/Risk Factor Table.

FIG. 10 is a display of Quality/Risk Adjusted Pricing Data Table.

FIG. 11 is a display of the Competitive Evaluation Weighting.

FIG. 12 is a display of the Comparative Pricing Data Table.

FIG. 13 is a display of the Comparative Evaluation Scoring Table.

FIG. 14 is a display of an Redefined Final Scoring column for Technical, Quality/Risk Adjusted Price, and Contract Quality/Risk.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. The term User in the following descriptions refers to the one employing the invention.

The process for measuring contract quality is applicable to all negotiated and non-negotiated documented actions and is intended to provide substantiating data and metrics necessary for performing a plurality of analytic actions to assist Users in making informed decisions. It is crucial for decision makers to have current complete and accurate information with respect to all aspects of a deal prior to signing the contract. Contract negotiations require considerable resources and effort in negotiating price, technical capabilities, and the like. The contract itself documents the deal and brings together all the negotiated elements. The resources expended, (people and time), in developing and reviewing a contract can be enormous. Yet when it comes time to sign a contract or one of multiple competing contracts, the question regarding which contract is better is not answered with substance. Current practices upon completion of contract negotiations are to note legally sufficient, without substantiating data supporting this determination. For example two vendors competing for a sale may reach agreement with two separate contracts one consisting of 70 pages the other consisting of only 27 pages. Both contracts are determined to be legally sufficient. Thus the factors that determine the better contract are subjective opinions. In addition to legal sufficiency, substantiating metrics must be developed and standards established to know measurable differences between contracts to make sound business decisions.

Contracts can be broken down into different groupings on differing tiers as they represent countless diverse agreements between parties. Initially contracts can be separated by field of application for example, information technology, employment, construction, mergers, divorce or any one of a plurality of contract groupings. In order to reveal the metrics possible with this invention the charts and diagrams in this document refer to, but are not limited to, Software Licensing Contracts which fall under the field of Information Technology, (IT).

Contracts are further sub-divided into multiple clause sections. Each section is comprised of multiple individual clauses grouped by the section's topic; for example Maintenance, Licensing or Performance. Clauses can be multiple sentences or even multiple paragraphs. It is the contract clause element level where measuring contracts is centered.

Creation of Contract Quality Measures

The process for creating substantiating metrics to measure Contract Quality/Risk, and the subsequent benefit derived from accurately measuring Contract Quality/Risk is described below.

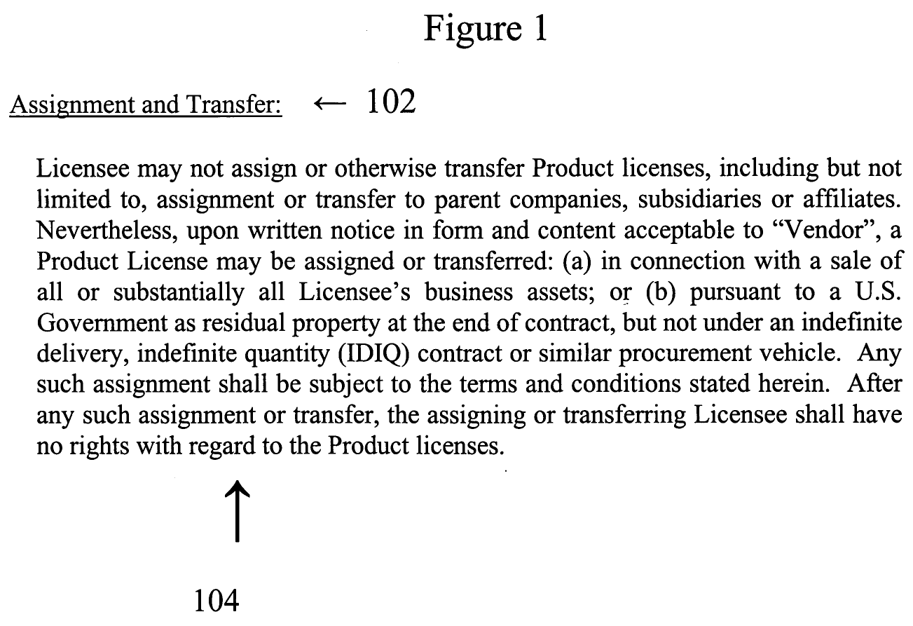

FIG. 1 is a sample of an individual contract clause. Block 102 represents the clause title and Block 104, represents the clause body. The body describes the User's rights, benefits, entitlements, obligations and limitations. The “User” is the party purchasing or the licensee and the “vendor” is the party selling or licensing. This clause example represents a vendor's perspective regarding the contract's transferred rights, i.e. “Assignment”, from the vendor's perspective. Contract negotiation is an iterative process by which both parties modify or redline the chosen document to include every clause, until both parties determine the contract acceptable. In the end, although the contract has been determined acceptable, the true relative quality remains unknown.

Method for Measuring Contract Quality/Risk

Step 1: Collect as many variations of software license contracts or pieces of contracts as possible from as many sources as possible.

Step 2a: Separate the collected contracts by section; such as software license, software maintenance, equipment, equipment maintenance, and professional services sections.

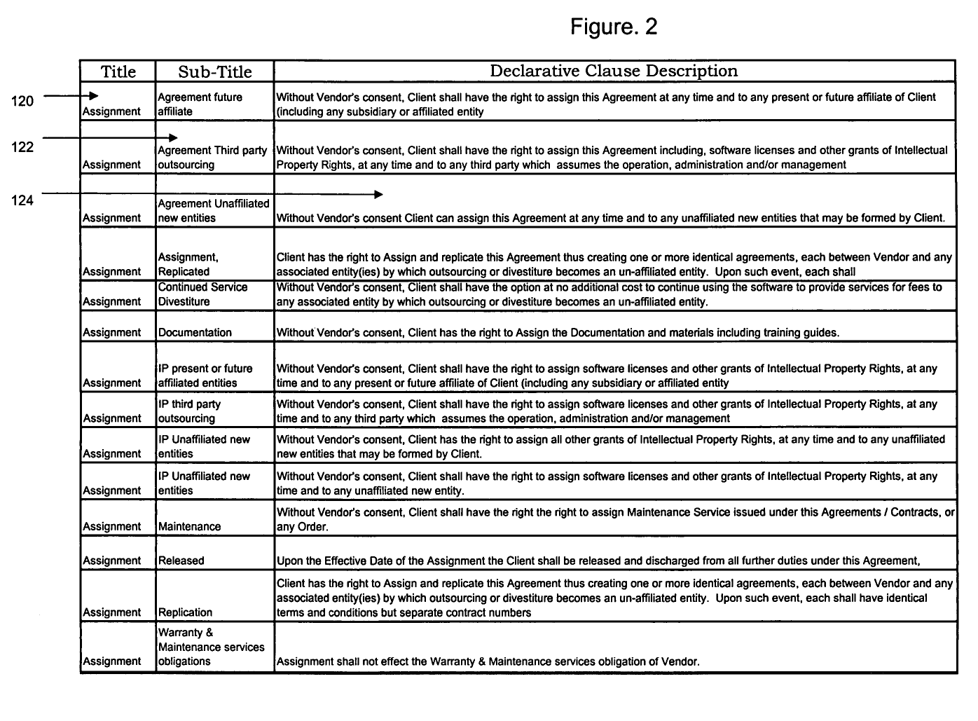

Step 2b: Subdivide the contract sections into contract clause groupings by clause title, (as shown in FIG. 2, block 120). Examples of contract clause group titles include: assignment, license grant, indemnity, default, and term are just of few of the potential clauses titles. Contract clause titles can be further subdivided down to the subtitle level which identify specific rights or obligations within the clause title (Block 122).

Step 3a: The contract clauses grouped by title are further subdivided into multiple micro elements (contract clause elements), (FIG. 2, Block 124). Each clause elements has a single, declarative, descriptive statement (FIG. 2, block 124), which can be answered with yes, no, most likely, or with a numeric character.

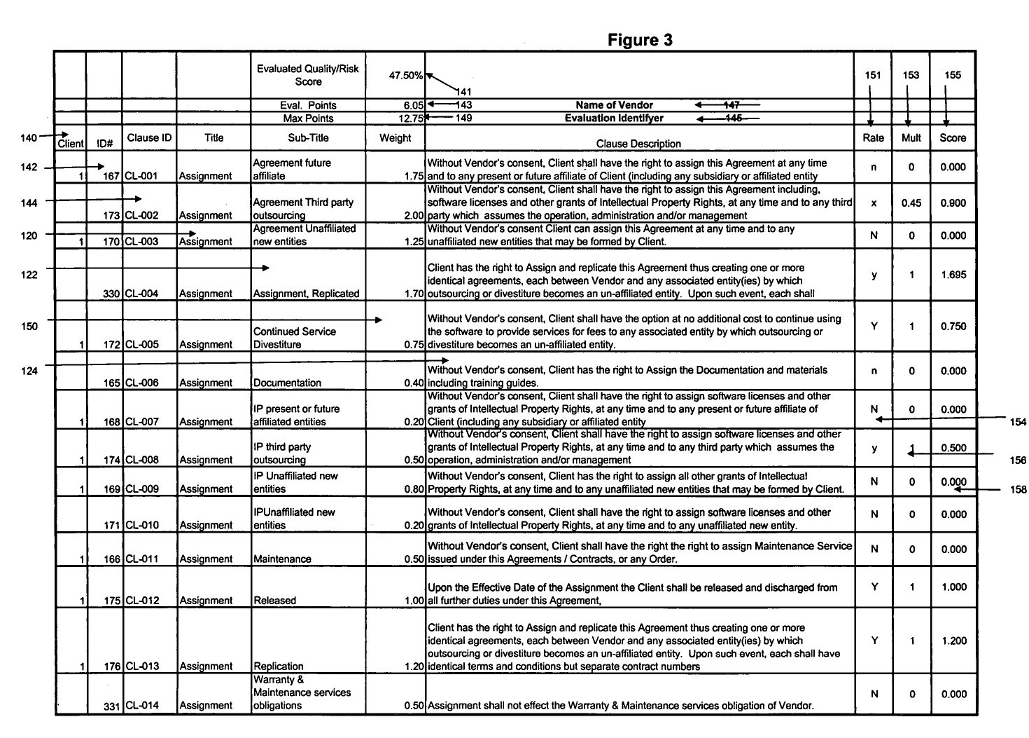

Step 3b: Create unique identifiers that will track each clause element to a specific client or other group to create multiple data tables supporting multiple clients. Clients are unique groups with different contract templates for which evaluations will be performed. (Block 140, FIG. 3). The client field is used to match clause elements with a specific client or supported group. This provides the User flexibility to have multiple clause element data tables for different client groups supported.

Step 4: Create a Master Contract Clause Database, a table containing all clause elements such as clause title, clause description, and multiple unique identifying fields as necessary (FIG. 3). All blocks mentioned in this step refer to FIG. 3. Block 140 represents the User's unique identifier to provide flexibility of supporting multiple clients. Block 142 represents the numeric clause identifier. This is used to index clause elements so that the clause elements can be displayed in sequence as determined by the User. Block 144 represents the clause identification number used to track clause elements by generic groupings such as contract sections or individual logical groupings as determined by the User. Block 144's value of “CL002” represents the clause section “Contract Legal” or (CL), the 002, signifies that this is the 2^{nd} contract legal clause in the data base. Block 122 represents the clause sub-title which is used to further define a clause element from its title. Block 150 represents the clause weight as assigned by the user. Clause weight can also be referred to as points or point value. Clause weighting is validated through a peer review process. The peer review is a process consisting of highly experienced contract negotiators, attorneys, and business professionals who collectively agree to the specific weighing or each clause element. Block 124 represents the clause element description. Clause element descriptions are limited to a single declarative statement representing the clause element. Block 154 represents the clause rating field. Block 156 represents the clause element rating factor. This is a factor used to calculate the clause element score. Block 158 represents the clause element score as calculated. Block 141 represents the Evaluated Quality Score of a contract revealing compliance with the User's active clause element data table as percentage of the maximum total possible score. Block 143 represents the aggregate total score which the contract being evaluated received. Block 149 represents the sum of all weighted clause elements for the active clause element data table. Block 145 represents a unique identifier for the contact being evaluated. Unique identifiers can be a contract number, proposal number or any other unique identifier. Block 147 displays the name of the vender whose contact is being evaluated. Block 151 represents the evaluation rating column. Block 153 represents the multiplication factor column used to calculate the clause element score. Block 155 represents the clause element score column.

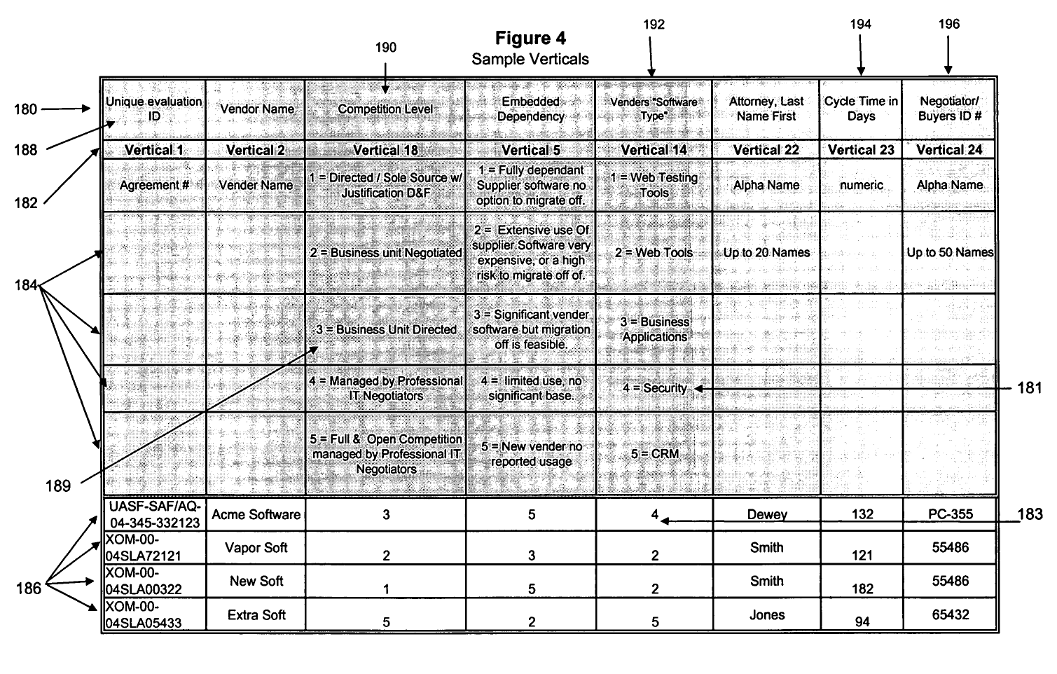

Step 5: The Master Contract Clause Database described in step 4, is created using a generally available commercial business software applications (software) such as Microsoft Word, Excel, or Access along with web enabling software for remote access to creating a database file of the size, and flexibility necessary for the User's needs. The database file is populated by means of entering data over time such loading contract clause element data every time the User evaluates a contract, or other data as needed. The data base file includes the clause element data, (FIG. 3), but also business variables associated with the circumstances that surround contract negotiation. FIG. 4 is a vertical chart revealing several of the business variables identified by the User for comparative analysis. Verticals vary between different contract families. Verticals are created or modified by the User based on professional experiences as to what drives contract quality/risk or for which business attributes the User chooses to measure. When evaluating a contract, the User will be prompted to yield an answer for each vertical. The User will select the best variable describing the contract being evaluated from within the verticals, or provide a specific answer as necessary. This selected variable indicator or answer is the data collected specific to an individual contract evaluation record in a particular vertical, (Block 183, FIG. 4). Each vertical generally has 3 to 5 Variables; however some verticals may only have only one variable while other may require a numeric value. Row 186, FIG. 4, represents the complete contract evaluation record for one specific contract. There are many rows representing many different contracts. The number of verticals varies and it is not uncommon to have up to sixty.

Block 180, FIG. 4, represents the vertical titles. Block 182, FIG. 4, references the vertical number which is used to track the verticals. Each vertical has multiple variables or sub-verticals which further define the vertical. Block 190, FIG. 4, represents the vertical 18 “Competition Level” which refers to the degree to which the negotiated contract was competed. The scale for determining Competition Level goes from a low of directed source or sole source, (variable 1) to a high of full and open competition managed by professional IT negotiators (variable 5) as seen in Block 192, FIG. 4. All blocks 184, FIG. 4, represent rows of multiple variables and a description of what each of the variables represents. Block 198, FIG. 4, represents variable #3 of vertical 18 “Business Unit Directed”. Block 181, FIG. 4, represents variable #4 (Security) of vertical 14, Software type.

Step 6: Using the software as described in step 5, input all the contract clause elements as created in step 3,

Step 7: Using the software as described in step 5, review the clause element description data as entered into the software and remove any duplicate data fields.

Step 8: Using the software as described in step 5, save or back up the data file creating a Master Contract Clause Element Data File.

Step 9: Create an Active “Software” Clause Element Data File from the Master Contract Clause Data File as described in step 8, (i.e.: “save as”). The Active Clause Element Data File contains only the clause elements which are resident in the User's contract specific to Software. To create the Active Software Clause Element Data File, a Unique Identifier is placed in FIG. 3, Block 140. This represents the User's Master Contract Clause Database to which the Active Clause Element Data File is identified so that it can be retrieved efficiently.

Step 10: Customize the Active Clause Element Data File. Each clause element is numbered sequentially as to directly correspond to the same order as in the User's Master Software Contract. Having the contract clause elements in the same order provides a seamless transition for the user to read and evaluate concurrently. Block 142, FIG. 3, is used to sequentially number the Active Clause Element Data File in the order in which the clause descriptions appear in the User's Software contract. Step 11: Configure the software as described in step 5, so that the User can access a new project or edit existing projects. The new project will consist of asking the users a series of questions which are all generated from the Active Clause Element Data File as created in step 9. The configured software will display both the clause elements and the business variable question one at a time and the user will be prompted to provide input.

Step 12a: Conduct the physical evaluation of historical and or new contracts assigning a value to the clause rating field as in FIG. 3, under the column of Block 151. The User reads the contract, clause by clause and utilizing the software as configured in step 11, enters a value into said column one clause element at a time. The clause rating field for each block such as FIG. 3, Block 151 contains one of four response options. The option 1 value is “Y” which represents an affirmative to the declarative statement in the clause element description. The option 2 value is “N” which represents a negative response to the declarative statement. The option 3 value is “X” which represents the evaluator can not make a positive determination as to a “Y” value and the element requires additional clarification. The option 4 value is a “numeric” representative of the declarative statement in the clause element description.

Step 12b: Concurrent to step 12a, the software will present the User with a series of deal specific business questions, “verticals”, with variable options, (FIG. 4). The deal specific business questions or verticals are designed to collect data representative of the circumstances surrounding the deal at the time of negotiation. This data is used in the comparative contract analysis.

Step 13: Repeating steps 12a, and 12b, until the User has answered every clause element and vertical question presented by the software to complete the contract evaluation. The action of completing steps 12a and 12b creates a single record for each contract evaluated, referred to as the Contract Evaluation Record (i.e.: FIG. 4, rows 186). The record contains all the data fields from both the Active Clause Element Data File and the business verticals. Each record is stored in the software as described in step 5.

Step 14: Repeat steps 12a, 12b, & 13, multiple times to create multiple Contract Evaluation Records necessary for performing comparative analysis.

Step 15: Measuring contract quality using the software as stated in step 5, to score each Contract Evaluation Record. Scoring is accomplished by multiplying the weight (Block 150, FIG. 3) of a specific clause element times (x) the corresponding factor from Column 153, FIG. 3. The factors in this column are determined by the Users at the time of creating the database. The fields under Block 151, FIG. 3, determine which rating factor to be used as represented by y=1, x=0.45, and n=0, as in Block 154. However if a numeric value or any other value other than Y, X, or N populates these blocks, the corresponding score has no calculation and a value of 0.0 is entered into the fields under Block 155, as in Block 158. For example a clause element with a weighting of 1.25, and the evaluation result of “y” or (1) results in a score or point value of “1.25”. If the clause elements weighting was 1.0, and the evaluation result for that clause element was “x” (0.45), then the resulting score or point value would be “0.45”. Similarly, if the clause element had a weighting of 1, and the evaluation result for that clause element was “n” (0.0) then the resulting score or point value world be “0.0”.

Step 16a: Calculating a Contract Evaluation Record's points using the software and the method as stated above in step 15. The software is used to sum all fields under Block 155, FIG. 3, which is the column representing the score for each clause element. The result or total score is entered into Block 143, FIG. 3.

Step 16b: Calculate a contract's maximum possible score using the software and the method as stated above in step 15. The software is used to sum the column representing the weighted score for each clause element (same column that contains Block 150, FIG. 3). The weighted score sum is the total maximum weighted score and is documented in Block 149, FIG. 3, at the top of the same chart.

Step 16c: Calculating a Contract's Evaluated Quality/Risk Score, (Block 141, FIG. 3) using the software and the method as stated above in step 15. The software is used to divide the Contract Evaluation Record's total points as calculated in step 16a, (Block 143, FIG. 3) by the maximum weighted score populating (Block 149, FIG. 3) to produce the Contract's Evaluated Quality/Risk Score which populates (Block 141, FIG. 3).

Step 16d: Storing the Contract's Evaluated Quality/Risk Score using the Software as described in step 5, the Contract's Evaluated Quality/Risk Score along with all the data associated with the Contract Evaluation Record is stored in the database.

Steps 1 through 16d describe the method for developing multiple contract standards and comparative contract business verticals. Negotiation leverage influences contract outcome which in turn affects the outcome in terms of contract quality/risk. These steps direct the creation of a flexible database for storing, tracking, and manipulating data as necessary for measuring contract quality. Having established contract standards by which negotiated contracts can be compared and having the ability to accurately measure contract quality to an established such standard launches the means for a plurality of analytic processes to be developed and employed.

Comparative Contract Quality Reference Ranges

Step 17: Creating Comparative Contract Quality Reference Ranges. FIG. 4 is a screen shot of several verticals. The User determines which contract quality reference range desired and selects the appropriate vertical from the database from FIG. 4. For this example the vertical selected is “Software type” (Block 192, FIG. 4) and the specific software type being evaluated and compared is “Security” (Block 181, FIG. 4).

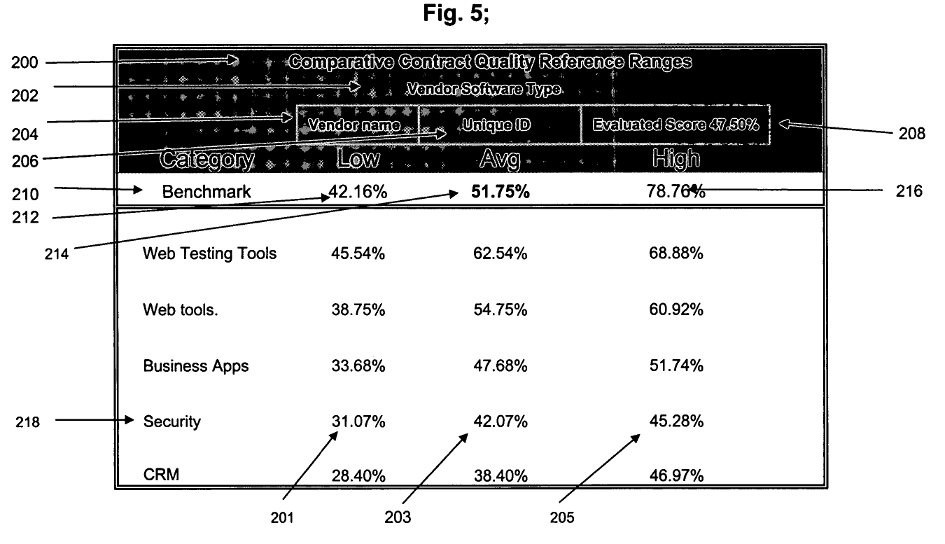

Step 18: Creating the Comparative Contract Quality Reference Ranges Table to illustrate the data ranges selected in step 17. A Comparative Contract Quality Reference Ranges Table is a means that allows the User to view contract quality/risk comparisons of one specific contract with all other contracts of specified variables in the database. All the data needed to create the reference tables is found in the database as entered in step 13, (Rows 186, FIG. 4). FIG. 5 displays a Comparative Contract Quality Reference Ranges Table which has three columns of data categories, (Blocks 212, 214, 216, FIG. 5): the Low range score, the Average score, and the High score. Each category row in FIG. 5 represents Software types from FIG. 4, Block 192, except for Benchmark, (Block 210, FIG. 5).

Step 19: Normalizing the data and completing the Comparative Contract Quality Reference Ranges Table. The ranges are normalized so that fringe scores on both the high and low end are eliminated. To normalize the data for creating the benchmark ranges the Evaluated Quality/Risk Scores of all evaluated contracts are indexed in sequential order from lowest to highest. The lowest 10% of scores are eliminated from consideration. The lowest score now becomes the benchmark low (FIG. 5, Block 212) The same process is used to determine the benchmark high except that the top 10% of high scores are eliminated and the highest score remaining populating (FIG. 5, Block 216). The average score (FIG. 5, Block 214) is calculated by eliminating both high 10% and low 10% of scores with 80% of scores being averaged. To calculate the low, average, and the high for Security Software is completed by selecting only the contract quality scores for Software type: Security as identified in the database (FIG. 4, Block 183). The sum of all evaluated contracts for Security are indexed in sequential order from lowest to highest and the calculations as described above for this step are applied to normalize the data. At the top of the table in FIG. 5 is the title, (Block 200). The selected vertical for the comparison in this table is represented in Block 202. The vendor's name is located Block 204; the unique identifier for the evaluated contract is in Block 206; the Evaluated Quality/Risk Score is displayed in Block 208.

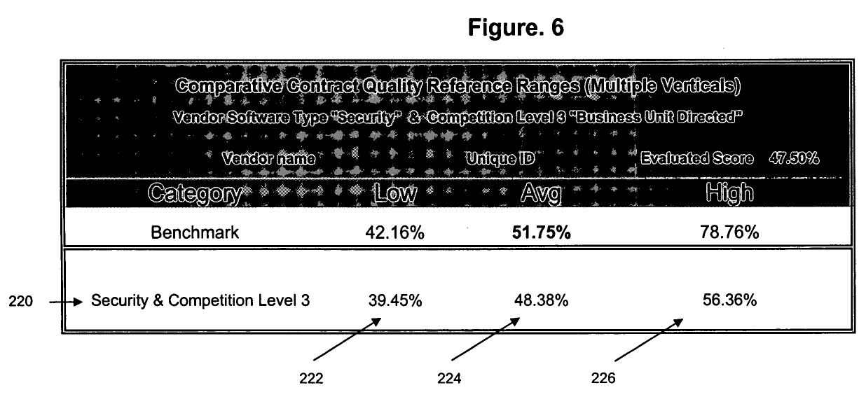

Step 20: Redefining quality ranges by incorporating additional vertical data with specific designated variables. The same process used in step 19 is used here however the data represented is from more than one vertical. Such redefined calculations for quality/risk range are shown in FIG. 6 chart. In this example, the data is excerpted from all contracts in the database that are Software type of the defined variable Security (i.e.: Security Software, FIG. 4, 181) and that are Competition Level of the defined variable Business Unit Directed, (i.e.: level 3, FIG. 4, 189). FIG. 6, Block 222 shows the Low Contract Quality Score for such grouping of contracts to be 39.45%. This is 8.5 percentage points higher than the calculation that did not take into consideration the Level of Competition existing during negotiations, (31.07%, FIG. 5, Block 201). Similar differences can be seen throughout FIG. 6, revealing higher quality scores. The adjustment made with the redefined calculations, and applying different variables, contributes substantiating data to the User: knowledge of what positively or negatively affects the quality/risk of the contract.

Comparative Contract Quality/Risk Negotiation Targets

A benefit of creating a process that measures contract quality and incorporates comparative measures is the ability to improve upon the current level of contract quality. Once you know where you are (the quality of your contract portfolio), you can chart a course for getting where you want to be (higher quality, lower risk contracts). *Creating Contract Quality Negotiation Targets equips negotiators with realistic measures with which to achieve a substantiated goal. As each new evaluation is completed and the data aggregated with pre-existing data, the reference ranges and negotiation targets are recalculated. This recent data, reflecting improved quality, in turn increases the accuracy of Contract Quality Negotiation Targets.

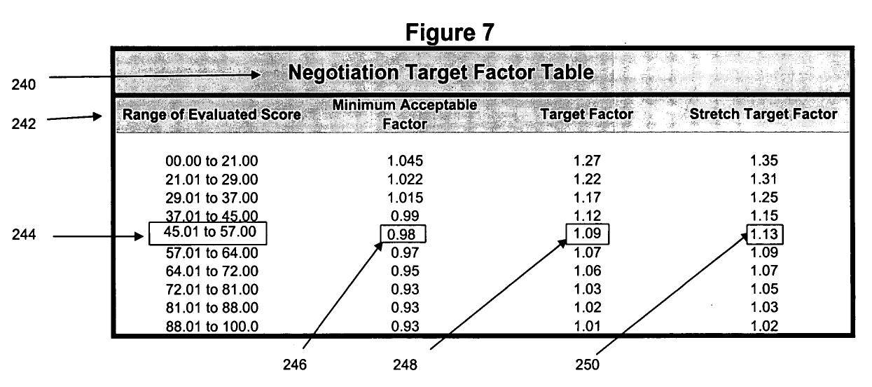

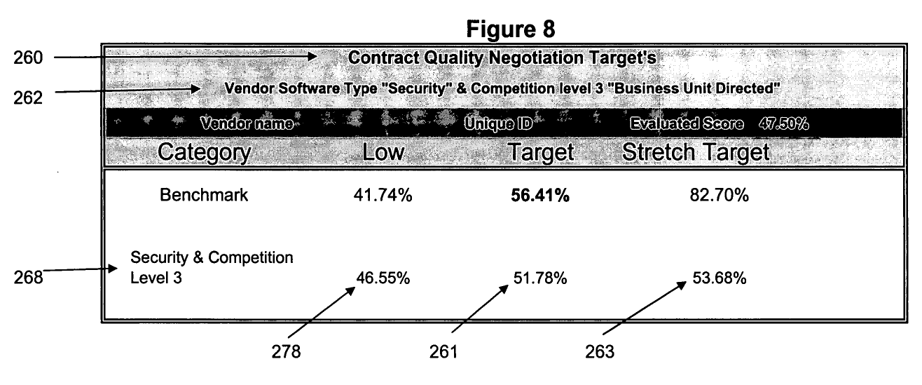

Step 21: Creating Contract Quality Negotiation Targets, FIG. 8. Contract Quality Negotiation Targets are based on the User established Contract Quality Negotiation Factor Table, FIG. 7. FIG. 7, Block 242 displays a column of Evaluated Contract Scores divided into multiple ranges. The range of the Evaluated Contract Score values of 45.01% to 57.00%, (Block 244, FIG. 7), is the row used for referencing any contract with an Evaluated Quality Score of 45.01% to 57.00% inclusive. To calculate the Minimum Acceptable Score for the Security Software contract, the Target Factor in (Block 246, FIG. 7) is multiplied against the Evaluated Quality Score, (Block 141, FIG. 3): (0.98*47.50)=46.55%. This resulting Minimum Acceptable Score calculation populates FIG. 8, Block 278. The factors in (Blocks 246, 248, & 250) are all created by the User based on professional experiences and validated through a peer review process. Statistical Analysis can be applied later as the volume of data collected increases. To calculate the Negotiation Target Factor, the Target Factor 1.09, (Block 248, FIG. 7), is multiplied against the Evaluated Quality Score of 47.50%, (Block 141, FIG. 3). The calculation (1.09*47.50)=51.78% which then populates FIG. 8, (Block 261). The Stretch Target Score is simply a quality score which is difficult to achieve but possible. To calculate the Stretch Target Score the Stretch Target Factor in Block 250 is multiplied against the Evaluated Quality Score of 47.50% (Block 141, FIG. 3): (1.13*47.50)=53.68% which then populates FIG. 8, Block 263.

Estimating the Unrealized Future Costs of a Contract(s) as Affected by Quality/Risk

Contract quality or risks are generally associated with cost, the lower the contract risk the higher the contract cost. It is widely held that the more contract risk a party takes the lower the initial contract cost will be. It's also held the higher the contract risk the higher the long term costs. A high risk contract will cost an organization more in the long run.

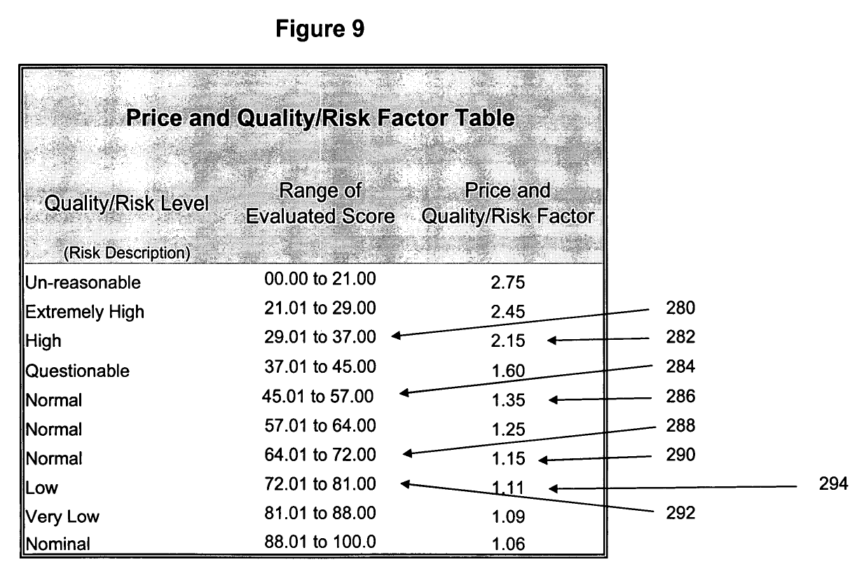

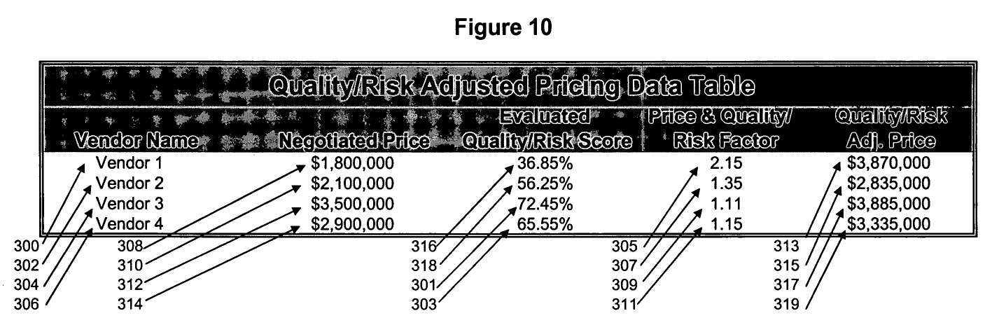

Step 22: Create a Price and Quality/Risk Factor Table, (FIG. 9). Each inclusive Evaluated Score Range is assigned a Price and Quality/Risk Factor, thus this Price and Quality/Risk Factor Table is created. This Price & Quality/Risk Factor is necessary to calculate the Quality/Risk Adjusted Price (FIG. 10). The Price and Quality/Risk Factor Table is created by the User, based on professional experiences and validated through a peer review process. Block 280, FIG. 9 represents an evaluation score range of 29.01 to 37.00 inclusive. All contracts that receive an evaluation score in this range are assigned the Price & Quality/Risk Factor of 2.15, (Block 282, FIG. 9). This Price & Quality/Risk Factor populates Block 305 of FIG. 10.

Step 23: Quality/Risk Adjusted Pricing Data Table, (FIG. 10), is created to illustrate the effects quality/risk have on negotiated or proposed pricing. The first column lists the name(s) of the vendors. In this example, four vendors are competing: vendors 1, 2, 3, and 4, (Blocks 300, 302, 304 and 306, FIG. 10). The second column represents the proposed prices from each vendor, (Blocks 308, 310, 312, and 314). The third column represents the Evaluated Quality/Risk Score for each vendor, (Blocks 316, 318, 301 and 303). The fourth column represents Quality/Risk Factor as created in FIG. 9, for each vendor, (Block 305, 307, 309 and 311). Quality/Risk Adjusted Pricing is determined by the following formula: Price and Quality/Risk Factor, is mathematically multiplied by the Negotiated Price. The result is the Quality/Risk Adjusted Price specific to each vendor. For Example:

The calculation for vendor 1 (Block 300) is as follows;

Price and Quality/Risk Factor×Negotiated Price=Quality/Risk Adjusted Price

(Block 305)×(Block 308)=(Block 313)

2.15×$1,750,000=$3,762,500

Determining the Bestvalued Contract of Compeing Contracts

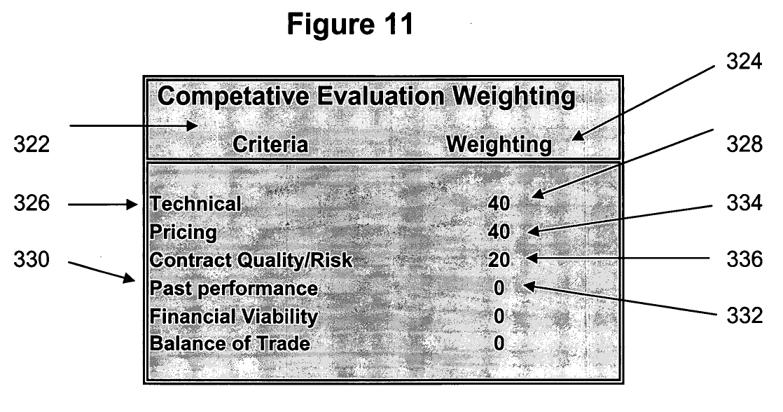

Measuring contract quality/risk provides negotiators and decision makers with diagnostic data to create comparison tables. Comparison tables are used to illustrate the competing vendor's scores for each of the established selection criteria. Selection criteria are used to determine which criteria is the most important. Weighting the evaluation criteria provides the user the means for determining which vendor presented the best overall deal. To determine the best overall deal the User creates the Competitive Evaluation Weighting Table comparable to the one in FIG. 11.

Step 24: Create the Competitive Evaluation Weighting Table, (FIG. 11). The first column in the table represents Criteria, (Block 322, FIG. 11). The second column represents the assigned criteria weight, (Block 324, FIG. 11), determined by the User based on the criteria's relative importance. The Technical Criteria (Block 326, FIG. 11) has a corresponding evaluation weighting of 40, (Block 328, FIG. 11). The Pricing Criteria has a corresponding evaluation weighting of 40, (Block 334, FIG. 11). The Contact Quality Criteria has a corresponding evaluation weighting of 20, (Block 336, FIG. 11). The User in this example decided not to weight Past Performance (Block 330, FIG. 11) therefore (Block 332, FIG. 11) has a value of 0. Not all evaluation criteria items must be weighted but the total weighting must equal 100% even if all is attributed to a single criteria. These weightings are necessary in the Competitive Evaluation Scoring.

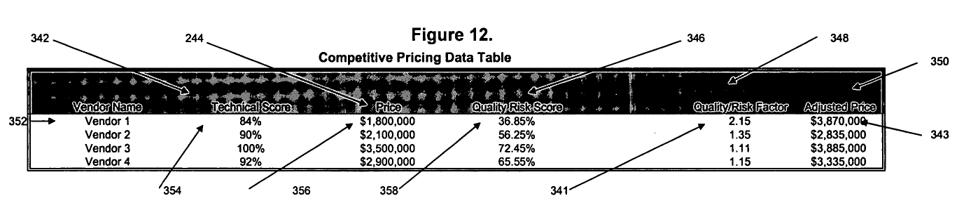

Step 25: Create a Competitive Pricing Data Table, (FIG. 12). This table displays data from Quality/Risk Adjusted Pricing Table (FIG. 10), aligned with the Competitive Evaluation Weighting for specified Criteria(s), (FIG. 11). The purpose is only to display the data that will be used in the Competitive Analysis. All Blocks referenced in this step are from FIG. 12. The columns in Competitive Pricing Data Table are as follows: competing vendors (Block 340), Technical Scores (Block 342), Contract Quality/Risk Scores (Block 346), Risk Factors (Block 348), and Adjusted Prices (Block 350).

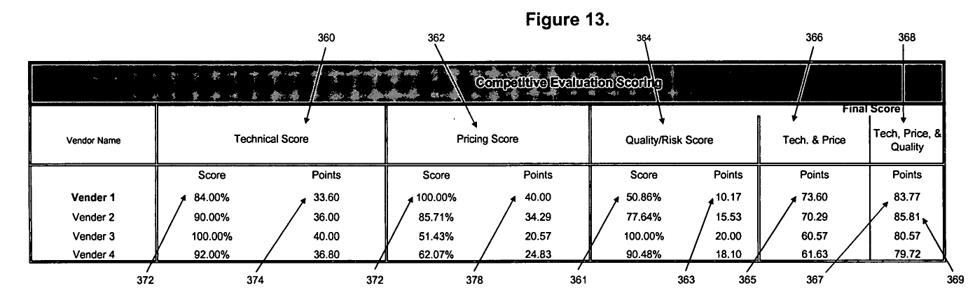

The Technical Score received by vendor 1 (Block 352) is 84% (Block 354). The technical ratings for all competing contracts evaluated are provided by the client's technical team. These are provided as a numeric value. The vendor receiving the highest numeric value from the client's technical team is awarded a technical score of 100%, in this case, vendor 3. Each of the remaining vender scores are a percentage of the vendor with the highest score. Thus, 84%, (Block 354) represents vendor 1's Technical Score as a percentage of vendor 3's Technical Score. Block 356 represents the price $1,800,000 as negotiated for vendor 1. Block 358 represents risk sore, (36.85%), as determined in step 16a. Block 341 represents the risk factor for vendor 1, (2.15), as determined in step 22. Block 343 represents the price as adjusted in step 22, for vendor 1. As a result of adjusting price for quality/risk, vendor 1's adjusted price went from a negotiated price of $1,800,000 to a Quality/Risk Adjusted value of $3,870,000. The process for determining Technical score from the ratings by the client's technical team is repeated for each of the competing vendors. Later, this data from FIG. 12 and FIG. 11 are used to populate the Competitive Evaluation Scoring Table, (FIG. 13).

Step 26: Create a Competitive Evaluation Scoring Table comparable to the one in FIG. 13. This table is used to calculate the Competitive Evaluation points for each criteria that has been weighted and then to calculate the total criteria scoring for each competing vendor. In FIG. 13, Block 360, the technical points assigned to each vendor based on the vendor's Technical Score is represented. Vendor 1's Technical Points are calculated by multiplying Technical Score (FIG. 13, Block 372) by Technical Weighting (FIG. 11, Block 328) yielding vendor 1's total Technical Points (FIG. 13, Block 374), in this case (0.84*40=33.60).

The column of Price Points assigned to each vendor based on the vendor's Pricing Score is represented in Block 362, FIG. 13. Vendor 1's Price Points are calculated by multiplying Price Score (FIG. 13, Block 372) by Price Weighting (FIG. 11, Block 328) yielding Vendor 1's total Price Points (FIG. 13, Block 378), in this case (1.0*40=40.00).

The Quality/Risk Points assigned to each vendor based on the vendor's Evaluated Quality/Risk Score, (FIG. 13, Block 364). Vendor 1's Quality/Risk Score are calculated by multiplying Evaluated Quality/Risk Score (FIG. 13, Block 361) by Quality/Risk Weighting as criteria (FIG. 11, Block 336) yielding Vendor 1's total Quality/Risk Points (FIG. 13, Block 363), in this case (0.5086*20=10.17).

In FIG. 13, the column that totals each vendor's points for Technical and Pricing criteria is found at Block 366. Block 365 is calculated by adding Blocks 374 & 378 (or 33.6+40.0=73.6). A review of the technical and pricing column reveals that vendor 1 with a point total of 73.60 (FIG. 13, Block 365) has the highest Competitive Evaluation Score and can be declared the winner under the evaluation criteria Technical and Pricing.

The column that totals each vendor's points for Technical, Pricing and Quality/Risk criteria is found at Block 368. Block 367 is calculated by adding Blocks 374 & 378 & 363 (or 33.6+40.0+10.17=83.77). A review of Technical, Pricing and Quality/Risk column reveals that vendor 2, with a point total of 85.81 (Block 369, FIG. 13) has the highest Competitive Evaluation Score and is now the winner based on the evaluation criteria Technical, Pricing and Quality/Risk.

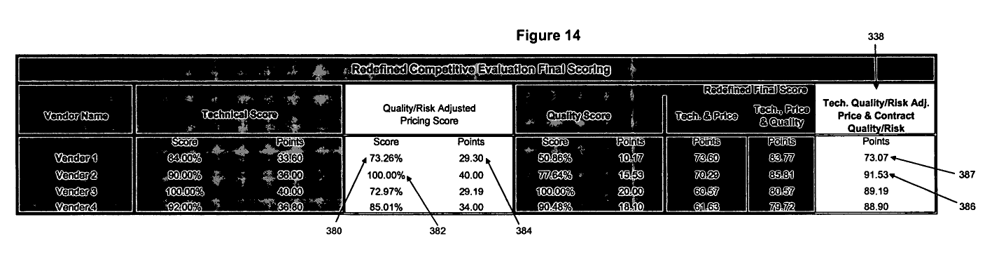

Competitive Evaluation Scoring is further enhanced by now including Quality/Risk Adjusted Price and is represented by FIG. 14: Redefined Competitive Evaluation Final Scoring. This table is comparable to FIG. 13 except that the Pricing Score column (Block 362, FIG. 13) is replaced with Quality/Risk Adjusted Pricing Score as described in step 23, (FIG. 10), the Final Score therefore is redefined as adjusted for Quality/Risk. The Quality/Risk Adjusted Pricing Score for vendor 1 is represented in FIG. 14, Block 380. The redefined score is calculated by first identifying the lowest Quality/Risk Adjusted Price of the Blocks 313, 315, 317 & 319 in FIG. 10. The vendor with the lowest Quality/Risk Adjusted Price receives 100% of the allocated points for the Competitive Evaluation Weighting for Pricing Criteria (FIG. 11, Block 334). Hence the weighting in Block 334 would allocate all 40 points to the vendor 2 who has the lowest Quality/Risk Adjusted Price (found by reviewing FIG. 10). This same lowest Quality/Risk Adjusted Price will dictate the value used to determine each subsequent vender's Adjusted Pricing score. The lowest Quality/Risk Adjusted Price (Block 315, FIG. 10) is divided by each subsequent vender's Quality/Risk Adjusted Price to obtain a percentage of the lowest price. This resultant percentage is then multiplied against Competitive Evaluation Weighting for the Pricing Criteria (Block 334, FIG. 11) for each vendor. The results entered in the appropriate vendors Redefined Final Score are in FIG. 14, Column 388. In review: the lowest Quality/Risk Adjusted Price is identified at FIG. 10, Block 315 and belongs to vendor 2. The value $2,835,000 (Block 315, FIG. 10) is divided by $2,835,000 (Block 315, FIG. 10) with the result being 1 or 100%. The value of 100% is then populated in Block 382 of FIG. 14. The subsequent Quality/Risk Adjusted Pricing score are calculated. For example, vendor 2's Quality/Risk Adjusted Price (Block 315, FIG. 10), is divided by vendor 1's Quality/Risk Adjusted Price (Block 313, FIG. 10) with the result being 73.26%, (Block 380, FIG. 14). This is repeated for each vendor's Quality/Risk Adjusted Price from FIG. 10.

Calculating the vendors Quality/Risk Adjusted Pricing Points is accomplished by multiplying each vendor's Quality/Risk Adjusted Pricing Score by the Competitive Evaluation Weighting for Price in (Block 334, FIG. 11). For example vendor 1's Quality/Risk Adjusted Pricing Score of 73.26% (Block 380, FIG. 14) is multiplied against the pricing criteria weighting of 40 (Block 334, FIG. 11). The result, 29.30, the Quality/Risk Adjusted Pricing Points, is entered into Block 384.

FIG. 14 calculates and displays a Redefined Final Score for the three criteria Technical, Contract Quality/Risk and now Quality/Risk Adjusted Price. Factoring in Contract Quality/Risk as criteria reduces the price scoring for all vendors. The amount reduced is essentially a function of the Evaluated Quality/Risk Score (Block 141, FIG. 3) and the Price and Quality/Risk Factor (FIG. 9). The greater the contract risk, the higher the price risk factor multipliers will be. As a result of recalculation, vendor 1's Redefined Final Score Points 73.07 (Block 387, FIG. 14) decreased by 10.7 points from the initially calculated Final Score Points 83.77 (Block 367, FIG. 13) for Technical, Price and Quality/Risk Criteria.

As a result of recalculation, vendor 2's Redefined Final Score Points 91.53 (Block 386, FIG. 14) increased by 5.72 points from the initially calculated Final Score Points 85.81 (Block 369, FIG. 13) for Technical, Price and Quality/Risk Criteria.

The invention identifies vendor 2 as the best value using substantiating data based on the three criteria Technical, Contract Quality/Risk and Quality/Risk Adjusted Price.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method for measuring contract quality/risk comprising:
a means for creating a Master Contract Clauses Database;
a means to reduce the Master Contract Clauses Database to individual clause elements;
a means to weight individual clause elements;
a means to extract the clause element data from individual contracts being evaluated
a means for commercial business computer and software to store, manipulate, and report the data.
a means to:
i) input new data elements;
ii) update the data base; and
iii) for accessing the system from remote locations;

2. A method for measuring contract quality/risk recited in claim 1 further comprising a method for creating Comparative Contract Reference Ranges comprising:
a means for creating a database to collect, manipulate, and report a plurality of comparative contract data;
a means for identify a plurality of comparative contract deal specific business attributes, “verticals”, representative of the business situation surrounding the contract being negotiated;;
a means for illustrating Comparative Contract Quality Reference Ranges;
a means to create the low or minimally acceptable end of the quality/risk score range;
a means to create the average of the score of the quality/risk range;
a means to create the high end of the quality/risk range; and
a means for commercial business computer and software to store, manipulate, and report the data.

3. A method for measuring contract quality/risk recited in claim 1, as further recited in claim 3, comprising a method for creating Comparative Contract Quality/Risk Negotiation Targets comprise:
a means for selecting specific one or more comparative contract data verticals.
a means for creating Negotiation Target factors;
a means to create the minimally acceptable quality/risk score target;
a means to create the Negotiation Target Quality/Risk Score;
a means to create the high or Stretch Quality/Risk Target;
a means to illustrate multiple vertical data for merging multiple Comparative Contract Quality/Risk Negotiation Targets representing a plurality of verticals,
a means for commercial business computer and software to store, manipulates, and report the data, and;
a means for recalibrating the data as described in claim 2, to include the final negotiated data.

4. A method for measuring contract quality/risk recited in claim 1, further comprising a method for estimating the unrealized future costs of a contract(s) as affected by contract Quality/Risk comprise:
a means for creating Price and Quality/Risk Factor Table;
a means for adjusting price to reflect the effects of Contract Quality/Risk;
a means for commercial business computer and software to store, to manipulate, and report the data;

5. A method for measuring contract Quality/Risk recited in claim 1, as further recited in claim 4, and further comprising a method for determining the best valued contract of competing contracts which comprise:
a means for identifying and collecting specific competitive evaluation weighting and criteria data:
a means for creating and illustrating Competitive Pricing Data;
a means for creating and illustrating Competitive Evaluation Scoring Data;
a means for creating and illustrating the Redefined Competitive Evaluation Scoring Data; and
a means for commercial business computer and software to store, manipulate, and report the data.
